(19) United States
(12) Patent Application Publication
(10) Pub. No.: US 2015/0017610 A1
(43) Pub. Date: Jan. 15, 2015

(54) FILTERED DIMENSION

(71) Applicant: Ashley SHEFFLER, Middletown, MD (US)

(72) Inventor: Ashley SHEFFLER, Middletown, MD (US)

(21) Appl. No.: 14/319,237

(22) Filed: Jun. 30, 2014

Related U.S. Application Data
(60) Provisional application No. 61/842,352, filed on Jul. 2, 2013.

(51) Int. Cl. B44C 3/08; B44D 5/00

(52) U.S. Cl. CPC B44C 3/087; B44D 5/00
USPC 434/82

(57) ABSTRACT

A process for creating three-dimensional art using coffee filters in a way that creates texture, depth, and form to make a relief sculpture or decorative collage. The process includes applying color to paper coffee filters and folding the paper coffee filters to produce artistic effects.

### CROSS-REFERENCE TO RELATED APPLICATION

This application claims benefit of priority to U.S. Provisional Patent Application Ser. No. 61/842,352 filed Jul. 2, 2013, the content of which is incorporated by reference in its entirety.

### FIELD

The present disclosure relates generally to sculptures, culture, and interior design. More particularly, the present disclosure relates to three-dimensional wall art.

### SUMMARY

In a three-dimensional structure according to one or more embodiments of the disclosed subject matter, attaching said structure to a wall may be done with greater ease. This ease in wall placement is a result of using coffee filters, which are lighter than materials traditionally used such as construction paper.

Objects and advantages of the disclosed subject matter will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. These drawings are for illustration purposes only and are not intended to limit the scope of the present disclosure in any way. Where applicable, some features may not be illustrated to assist in the illustration and description of underlying features. Throughout the figures, like reference numerals denote like elements. As used herein, various embodiments can mean one, some, or all embodiments.

FIG. 1 depicts a paper coffee filter at a resting state.

FIG. 2 depicts a paper coffee filter that is folded in just less than half.

FIG. 3 depicts a paper coffee filter turned sideways, wherein the back half 1 of the filter is folded to make a frusto-conical shape.

FIG. 4 depicts a paper coffee filter turned sideways, wherein the back half of the filter is folded to make a frusto-conical shape, and the untouched part 3 of the coffee filter is folded at a 45° angle that overlaps the first fold 4.

FIG. 5 depicts a paper coffee filter turned sideways, wherein the back half of the filter is folded to make a frusto-conical shape, and the untouched part of the coffee filter is folded at a 45° angle that overlaps the first fold. The 45° angle is ripped 6 where the index finger will be to make a 90° angle.

FIG. 6 depicts a paper coffee filter that roughly resembles the shape of a hand.

FIG. 7 depicts a paper coffee filter that has been shaped to resemble a hand.

FIGS. 8 and 9 depict three-dimensional structures using paper coffee filters and employing the methods described in the present disclosure. FIGS. 8 and 9 are gray-scale images of structures that have been made using colored paper.

### DETAILED DESCRIPTION

One or more embodiments of the disclosed subject matter can provide a process for producing wall art that is made from coffee filters. More particularly, this process produces three-dimensional, colored wall art that is lighter in weight than art made from traditional materials such as construction paper.

The processes described herein may be employed by a person or persons, or, alternatively, by other means such as a machine.

To produce a three-dimensional structure as described above, the first step is to apply color to at least one paper coffee filter. After color is applied to the at least one coffee filter, the at least one coffee filter is shaped into at least one desired shape.

Alternatively, the steps may be reversed. In another embodiment, the first step is to shape at least one paper coffee filter into at least one desired shape. After the at least one coffee filter has been shaped, color is applied to the at least one paper coffee filter. Color may be applied to bleached or unbleached paper coffee filters.

In an embodiment, the step of applying color to at least one paper coffee filter is accomplished by applying color directly to the at least one coffee filter, attaching colored paper to the at least one paper coffee filter, or applying color directly to and attaching colored paper to the at least one paper coffee filter.

In an embodiment, the step of applying color directly to the at least one coffee filter is accomplished by staining, applying paint, or coloring. Coloring may be applied by way of a coloring instrument. Exemplary coloring instruments include, but are not limited to, paintbrush, colored inkpen, colored pencil, chalk, or crayon.

In an embodiment, the step of applying color to at least one paper coffee filter is accomplished by attaching colored paper to the at least one paper coffee filter.

Colored paper may be attached to the at least one coffee filter in one way or a combination of several ways. For example, colored paper may be attached to the at least one coffee filter by an adhesive. Exemplary adhesives include, but are not limited to, glue and construction adhesive. Another way in which colored paper may be attached to the at least one coffee filter is by mechanical attachment. Methods of mechanically attaching the colored paper to the at least one coffee filter include, but are not limited to, stapling, taping, and clipping the colored paper to the at least one paper coffee filter.

In an embodiment, colored paper is selected from the group consisting of paper bags, tissue paper, copy paper, hand-made paper, fair-trade paper, or colored paper coffee filters. It is very common to reuse paper bags or paper products that have vivid colors or patterns.

Use of colored paper is preferred over applying color directly because the paper creates a texture and a touch that furthers the beauty and innovation of an extremely detailed process.

In an embodiment, colored paper comprises colored tissue paper.

In another embodiment, colored paper comprises colored fair trade paper.

In an embodiment, the three-dimensional structure made from at least one paper coffee filter is attached to a wall. The structure may be attached by any traditional method, such as nailing the structure to a wall or securing the structure to a wall using hooks.

In an embodiment, the three-dimensional structure made from at least one paper coffee filter is attached to a flat surface. Exemplary flat surfaces include, but are not limited to, wooden boards, metal boards, corkboards, paperboards, fabric, and plastic boards.

The paper coffee filter according to the principles of the disclosed subject matter may include a generally circular perimeter top edge, a circular bottom surface, and one or more frusto-conical side surfaces. In this embodiment, the filter defines a frusto-conical shape about the axis of the center of the circular bottom surface when the side surfaces are folded in toward the bottom surface, though the configuration may not be perfectly conical. Paper coffee filters are semi-permeable paper barriers which can be used to separate solids from liquids or air. Paper coffee filters are typically made from about 100 g/m² crêped paper and are available in bleached and unbleached varieties and come in different shapes and sizes. Paper coffee filters are typcially comprised almost entirely of wood fiber. Porosity levels are comparable to paper filters used in coffee-making.

The present disclosed subject matter is not limited to conical or frusto-conical coffee filters, however. Recognizing that coffee filters are varied in shapes and sizes in accordance with the specifications of the machines into which they are designed to fit, it is an object of the disclosed subject matter to encompass any size or shape of paper coffee filter.

Art produced according to principles embodying the disclosed subject matter allows unique designs requiring a method of folding and layering a material to be incorporated.

The coffee filter is folded differently depending on the object being made.

In an embodiment, the coffee filter is folded and then soaked in an adhesive and left to dry. Once the shape has settled, the surface is smoothed by wrapping it in a second layer of filter followed by a colored paper. The coffee filter is the medium used to create the framework of the collage. The colored paper is applied to the coffee filter, and the process of applying and layering these materials produces artistic texture and visual movement.

One creating a structure according to the disclosed subject matter should have a distinct plan for the object or objects to be made. One creating a structure according to the disclosed subject matter should be aware of the width, length, and energy of the body part or object to be constructed. For example, one employing the process according to the disclosed subject matter may wish to craft a hand from the at least one paper coffee filter. To do so, one creating a structure according to the disclosed subject matter should consider the visual and physical weight of the coffee filter “wrist,” the ability of the “wrist” to hold the “palm” and five “fingers,” and the shape and drying process of the material.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, methods of producing three-dimensional structures and the structures produced by such methods. While specific embodiments have been shown and described in detail to illustrate the application of the principles of the present invention, it will be understood that the invention may be embodied otherwise without departing from such principles. Accordingly, Applicant intends to embrace all such alternatives, modifications, equivalents, and variations that are within the spirit and scope of the present invention.

### EXAMPLE 1

The following example demonstrates how one creating a structure according to the disclosed subject matter may make a hand according to the principles embodying the disclosed subject matter.

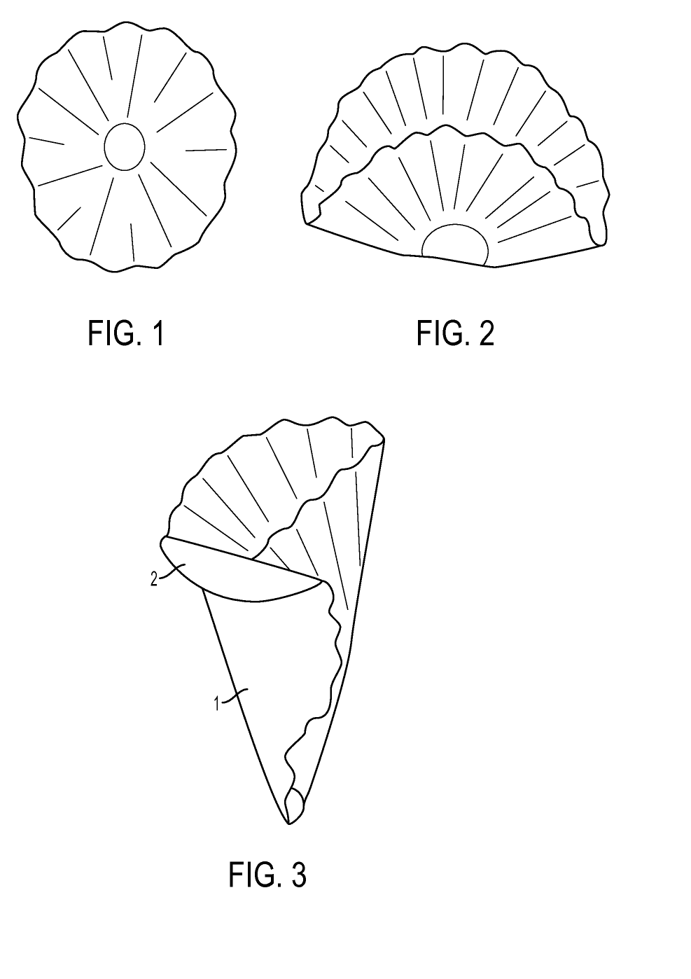

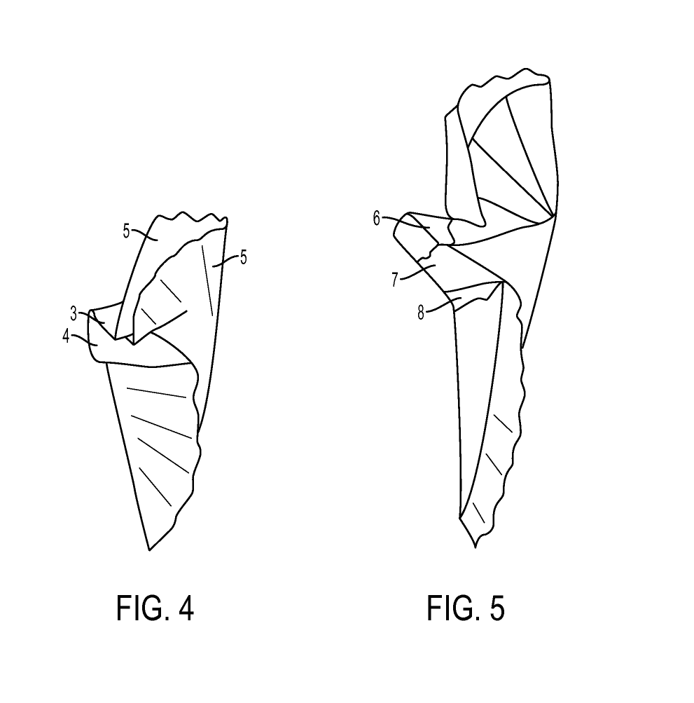

FIG. 1 shows the coffee filter at a resting state. The coffee filter is then folded in a little less than half to make FIG. 2. In FIG. 3, the filter is turned sideways and the back half 1 of the filter is folded to make a frusto-conical shape. The ripple 2 of the filter is folded down after the frusto-conical shape has been established. This fold will soon be the thumb.

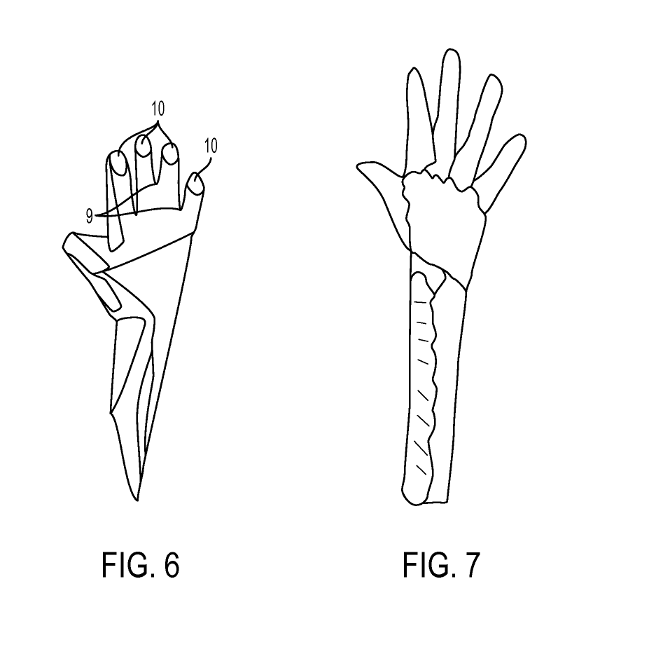

In FIG. 4, the thumb is the focus. The untouched part 3 of the coffee filter is folded at a 45° angle that overlaps the previous fold 4 of FIG. 3 to establish what will be the remaining four digits 5 of the hand. In FIG. 5, the 45° angle is ripped 6 where the index finger will be to make a 90° angle. The tip 7 of the thumb is then folded, while the wrist beneath the thumb also is torn 8 just a bit, so that it can be folded to make a much thinner form than in previous figures. In FIG. 6, a slit is made at the tip of the figure to create the four digits. The end of each filter is then folded down to represent fingertips. The ripples of coffee filter that remain on the wrist are rolled into the wrist in a manner that rounds out the shape. FIG. 7 represents taking pieces of coffee filter to wrap each finger. This is done for several reasons. First, it helps round out the structure as was just done with the wrist. Second, it furthers the separation of each digit, yet ultimately makes the surface smooth. This structure is then covered with a colored paper to disguise the coffee filter. Lastly, the structure is attached to a “body” that has been made in a similar fashion and then attached to a thin wooden board.

### EXAMPLE 2

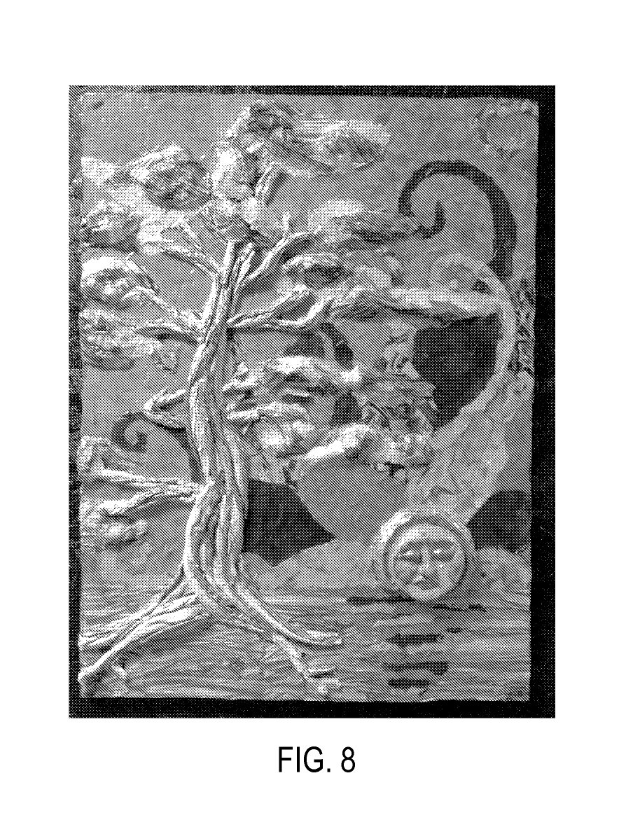

In FIG. 8, paper coffee filters as described in the present disclosure were colored and folded according to the process described in the present disclosure.

### EXAMPLE 3

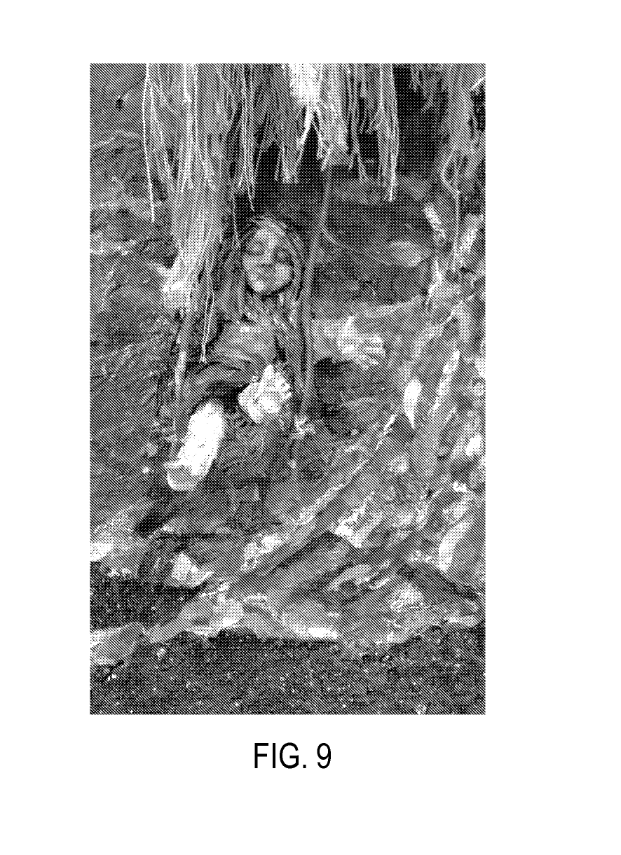

In FIG. 9, paper coffee filters as described in the present disclosure were colored and folded according to the process described in the present disclosure.

What is claimed is:

1. A process for creating a three-dimensional structure comprising the steps of applying color to at least one paper coffee filter, and shaping the at least one paper coffee filter into at least one desired shape.

2. The process according to claim 1, wherein the step of applying color to the at least one paper coffee filter comprises applying paint to the at least one paper coffee filter.

3. The process according to claim 1, wherein the step of applying color to the at least one paper coffee filter comprises applying color to the at least one paper coffee filter.

4. The process according to claim 3, wherein the color is applied using a coloring instrument.

5. The process according to claim 4, wherein the coloring instrument is selected from the group consisting of paintbrush, colored pencil, chalk, or crayon.

6. The process according to claim 1, wherein the step of applying color to the at least one paper coffee filter comprises attaching colored paper to the at least one paper coffee filter.

7. The process according to claim 6, wherein the colored paper is attached by means of an adhesive.

8. The process according to claim 6, wherein the colored paper is mechanically attached to the disposable coffee filter.

9. A three-dimensional structure produced according to the process of claim 1.

10. The process according to claim 6, wherein the colored paper is selected from the group consisting of paper bags, tissue paper, copy paper, hand-made paper, or colored paper coffee filters.

11. The process according to claim 1, further comprising a step of attaching the structure to a wall.

12. The process according to claim 1, wherein the steps are performed by a machine.

13. A three-dimensional structure resembling a human hand produced according to the process of claim 1.
